(19) United States
(12) Patent Application Publication
(10) Pub. No.: US 2017/0228792 A1
(43) Pub. Date: Aug. 10, 2017

(54) ONLINE MARKETING METHODS USING SOCIAL NETWORKS

(71) Applicant: DISTRIBION, INC., Dallas, TX (US)

(72) Inventor: Tim Storer, Dallas, TX (US)

(21) Appl. No.: 15/316,754

(22) PCT Filed: Jun. 10, 2015
(86) PCT No.: PCT/US15/35187

§ 371 Date: Dec. 6, 2016

Related U.S. Application Data
(60) Provisional application No. 62/010,434, filed on Jun. 10, 2014.

(51) Int. Cl. G06Q 30/02; G06Q 50/00

(52) U.S. Cl. CPC G06Q 30/0271; G06Q 30/0277; G06Q 50/01

(57) ABSTRACT

Methods, systems, and devices are disclosed for providing online marketing using social networks. In one aspect, a computer system facilitates operations by administrators representing an entity and subscribers affiliated with the entity and registered to one or more social networks via social media sites that link a subscriber with individuals within the social network. The system is configured to receive (i) content information generated by an administrator, (ii) user information about the subscribers, and (iii) authorization by the subscribers permitting access to their social media site accounts designated by the respective subscribers. The system is configured to produce an individualized message capable of being displayed to the individuals of the subscribers' authorized social networks on behalf of each unique subscriber, in which the individualized message includes the content information and virtual content tag(s) that corresponds to the user information of the corresponding subscriber.

### CROSS-REFERENCE TO RELATED APPLICATIONS

This patent document claims the benefits and priority of U.S. Provisional Patent Application No. 62010,434, entitled “ONLINE MARKETING METHODS USING SOCIAL NETWORKS,” filed on Jun. 10, 2014. The entire content of the aforementioned patent application is incorporated by reference as part of the disclosure of this application.

### TECHNICAL FIELD

This patent document relates to systems, devices, and processes for online marketing.

### BACKGROUND

Social media can be used for facilitating interactions among people in which they create, share, or exchange information and ideas, e.g., including shared interests, activities, backgrounds, or real-life connections, in virtual communities and networks, e.g., typically over an online social network.

### SUMMARY

Disclosed are methods and systems for providing online tools (e.g., on a website, intranet, etc.) to allow users (subscribers) to authorize their social networks to receive content from a particular source or brand that is distributed en masse to the authorized social network contacts such that the content appears as a message or post from the individual subscriber.

In one aspect, a system includes one or more computers in communication with a plurality of remote computing devices operated by administrator users and by subscriber users of a social network via a communication network or link, in which an administrator user represents an entity, and a subscriber user is affiliated with the entity and is a registered user of one or more social networks via social media sites that link the subscriber user with individuals within the social network. The system is configured to receive (i) content information generated by the administrator user, (ii) user information about the subscriber user, and (iii) authorization by the subscriber user permitting access to one or more of the subscriber user's social media site accounts designated by the subscriber user. The system is configured to produce an individualized message capable of being displayed to the individuals of the subscriber user's authorized social networks on behalf of the subscriber user, in which the individualized message includes the content information and at least one virtual content tag that corresponds to the user information of the corresponding subscriber user.

In some aspects, a method for providing personalized online marketing information includes a process to receive content information generated by an administrator user of an entity. The method includes a process to receive user information about a subscriber user affiliated with the entity, in which the subscriber user is a registered user of one or more social networks via social media sites that provides an online linkage of the subscriber user with individuals within the social network. The method includes a process to receive an authorization by the subscriber user to permit access of the computer system to one or more authorized social networks designated by the subscriber user. The method includes a process to produce an individualized message capable of being displayed to the individuals of the one or more authorized social networks on behalf of the subscriber user, in which the individualized message includes the content information and at least one virtual content tag that corresponds to the user information of the corresponding subscriber user.

In some aspects, a method for distributing personalized content across social network platforms, includes generating, at a computer system of one or more computers, content information to be distributed to a plurality of recipients across one or more social networks that provide an online linkage of registered individuals within the social network; obtaining, at the computer system, user information from a user who is a subscriber user affiliated with the entity and is a registered user of the one or more social networks; receiving, at the computer system, an authorization by the user to permit access of the computer system to pre-authorized connections among the registered users of the one or more authorized social networks designated by the user; producing, by the computer system, an personalized message capable of being displayed to pre-authorized connections of the one or more authorized social networks on behalf of the user, in which the personalized message includes the content information and at least one virtual content tag that corresponds to the user information of the user; and delivering, by the computer system, the personalized message to a host system facilitating the social media site using an account of the registered user corresponding to the subscriber user.

In some aspects, a method for distributing personalized content to contacts on social network platforms includes, at a computer system of one or more computers, generating a master message including content information pertaining to an entity to form a distribution message to be distributed on behalf of a subscriber user to a plurality of recipients across one or more social networks, in which the master message is generated to include (i) one or both of text and graphics to convey the content information and (ii) dynamic tags that maps to personalized information associated with the subscriber user into the distribution message, thereby allowing the distribution message to be uniquely different for each subscriber user, and in which the plurality of recipients include registered users of the one or more social networks having a connection with the subscriber user on the respective social network; receiving, at the computer system, a delivery time of the distribution message; obtaining, at the computer system, the personalized information associated with the subscriber user, in which the subscriber user is affiliated with the entity and is a registered user of the one or more social networks; receiving, at the computer system, an authorization by the subscriber user to permit the computer system access to authorized social networks of the one or more social networks designated by the subscriber user; producing, by the computer system, the distribution message by inserting the corresponding personalized information for the dynamic tags in the master message such that the distribution message is capable of being displayed to the recipients on behalf of the subscriber user; and delivering, by the computer system, the distribution message at the delivery time to one or more host computer systems corresponding to the one or more social networks using an account of the subscriber user.

In some aspects, a system for providing online marketing includes a network including one or more computers in communication with a plurality of remote computing devices operated by administrator users and by subscriber users of a social network, in which an administrator user represents an entity, and a subscriber user is affiliated with the entity and is a registered user of one or more social networks via social media sites that link the subscriber user with individuals within the social network. The system is configured to receive (i) content information generated by the administrator user, (ii) user information about the subscriber user, and (iii) authorization by the subscriber user permitting access to one or more of the subscriber user's social media site accounts designated by the subscriber user. The system is configured to produce an individualized message capable of being displayed to the individuals of the subscriber user's authorized social networks on behalf of the subscriber user. The individualized message includes the content information and at least one virtual content tag that corresponds to the user information of the corresponding subscriber user.

The subject matter described in this patent document can be implemented in specific ways that provide one or more of the following features. For example, the disclosed technology can include an exemplary online marketing tool, e.g., such as a software widget and/or a web portal managed by a computer system, to enable an authorized administrator (Admin) for the brand or content source to create and schedule delivery of content information (posts) to be presented to individuals of the social network of a subscriber using existing social media that the subscriber authorizes. The posts appear to the individuals on the social media site(s) as if the subscriber submitted the content directly to their social networks themselves. Also, for example, the disclosed technology can provide web analytics including tracking statistics and reports that present the ‘social reach’ of an organization, e.g., including quantitative data on the amount of aggregated networks and individuals the posts reached and were accessed. For example, the disclosed systems and methods can be implemented to report on the number of people that can potentially view a post (e.g., the social reach), and thus include the ability to generate the total number of followers, friends, connections, etc. across all subscriber users that have authorized their networks to receive content from the centralized source. This allows the administrator (e.g., corporate marketer) to see how large the total audience is that can potentially view the post.

### BRIEF DESCRIPTION OF THE DRAWINGS

FIG. 1A shows a process diagram of an exemplary online information creation and distribution tool of the disclosed technology.

FIG. 1B shows a diagram of an exemplary computer system and processing unit configured to implement the disclosed technology.

FIG. 1C shows a diagram of an exemplary method of the disclosed technology.

FIG. 1D shows a diagram of exemplary processes of the method of FIG. 1C.

FIG. 1E shows a diagram of a communication network for implementing the disclosed technology across one or more social network platforms subscribed to by individual users.

FIG. 2 shows an exemplary display screen of a user interface of the exemplary online marketing tool showing a subscriber user's social networks for authorization.

FIG. 3 shows an exemplary display screen of an interactive user interface of the exemplary online marketing tool showing a subscriber user's profile information.

FIG. 4 shows an exemplary display screen of an interactive user interface of the exemplary online marketing tool showing a created content post.

FIG. 5 shows an exemplary display screen of an interactive user interface of the exemplary online marketing tool showing listings of user groups.

FIGS. 6 and 7 show exemplary display screens of an interactive user interface of the exemplary online marketing tool showing a subscriber user's landing page.

FIG. 8 shows an exemplary display screen of an interactive user interface of the exemplary online marketing tool showing an example of a generated report of viewer access across authorized social media channels.

FIG. 9 shows an exemplary display screen of an example preview to a subscriber user depicting individualized messages to be delivered to the user's connections on authorized social networks.

### DETAILED DESCRIPTION

Online marketing or Internet marketing uses the Internet as a medium to provide information such as promotional messages or advertisements from a business to a consumer, such as a prospective or current customer or client. Some forms of online marketing include email marketing, search engine marketing, display advertising (e.g., web banner advertising), etc. With the growing use of social media, there is interest to create and provide online marketing tools to disseminate information using social networks.

An online social network is a service, platform, or site using mobile and web-based technologies operated on computer systems that generally focuses on social linkages and relations between individuals, groups, and/or organizations which form a social structure determined by their interactions, such as sharing, co-creation, and modification of user-generated content. A social network service can include a representation of each user (e.g., as a user profile), social links, and a variety of additional services, e.g., such as providing photos, lists of interests, contact information, and other personal information about the user. Online social network services are web-based and provide means for users to interact over the Internet, e.g., such as private or public messaging, e-mail, instant messaging, etc. Such social networking services allow users to share photos, ideas, activities, events, and interests within their individual networks. For example, a network host (e.g., one or more servers) collects and stores data provided from the individual clients (e.g., the user's computer, such as his/her desktop, laptop, smartphone, tablet, or wearable computing device that features a software application or web-based portal (e.g., website) of the social network). The host structures user interfaces presented to the users on their client devices, and facilitates communication between connected users within the social network, e.g., in the form of messages, posts, pings, likes, or other method of communication on the social network service.

Presently, personalized communications between individual users on their client computers over the social network, i.e., between a sender and one or more recipients, e.g., such as a message sent to or content post posted on the recipient'ss' account, require the sender to manually create the personalized message or content post and manually select the recipient or recipients, in which the intended recipient's name and other attributes must be manually inserted into the message or post by the individual sender. This process is inefficient not only to the individual users in terms of time that must be spent to select and personalize a message specifically to the intended recipient(s), but also inefficient with respect to resources utilized on the social network host computer, e.g., including excess data communications between the sender's client and the network host to construct the separate messages to be sent to the intended recipients.

Disclosed are methods and systems for providing online information distribution tools (e.g., on a website, intranet, etc.) to allow users (subscribers) to receive content from a centralized source and distribute the content to the subscribers' authorized contacts or connections from their social networks en masse, e.g., as if the distributed content appears as a message or post from the individual subscriber.

An exemplary online marketing tool of the disclosed systems and methods can include a software widget and/or a web portal managed by a computer system including one or more computers in communication with user devices via wired and/or wireless communication links. The computer system can be included as part of a communication network accessible via the Internet (referred to as ‘the cloud’) that includes one or more remote computational processing devices (e.g., servers in the cloud). For example, the software widget and/or web portal can be implemented on a user's computing device via a web browser or a software application. In the simplest form, such a computing device includes at least one processor (e.g., a microprocessor) and at least one memory that is in communication with the processor. The memory can, for example, include processor executable code, which when executed by the processor, configures the device to perform various operations, such as receiving information, commands, and/or data, processing information and data, and transmitting or providing information/data to another entity or to a user. Examples of the user's computing device can include a desktop or laptop computer, and/or a mobile computing device including a smartphone, a tablet, and/or a wearable communications device, e.g., such as a smart-watch or smart-glasses.

The exemplary online marketing tool allows users (e.g., subscribers) to authorize their social networks to receive content from a content source (e.g., the brand, or other type of content source). An authorized administrator for the brand or content source (e.g., Admin) can login to a web-based platform of the disclosed system, e.g., via the web portal and/or software widget, and schedule one or more content messages (posts) at specified times that are presented (e.g., posted, tweeted, delivered, presented) to the social networks of the subscribers that are authorized by those subscribers. The posts will appear on the social networks as if the subscriber submitted the content directly to his/her social networks him/herself. For example, the subscriber user can include an employee, partner, local representative, or other affiliate of the brand or content source. In some implementations, for example, the exemplary online marketing tool may allow the subscriber user to schedule the one or more content messages (posts) at the subscriber's preferred times to be presented to the subscriber's authorized social networks.

Implementation of the disclosed information distribution technology increases efficiency of computing resources of the social network, as well as reduces excess computational resources on the client device and server, and reduces network traffic that increases efficiencies on the communication infrastructure of the Internet. Such increased efficiencies are created while also providing automated personalized content that increase a user's ‘social reach’ to distribute the personalized content across one or multiple social network platforms.

The disclosed system can provide web analytics including tracking statistics and reports that present the ‘social reach’ of an organization to the Admin the total amount of aggregated networks for each user, as well as total amount of aggregated followers across those networks. In an illustrative example, if an organization includes 100 employees, partners, and/or affiliates implementing the exemplary online tools as subscribers, and each subscriber authorizes three social networks, in which each social network of each subscriber has 200 followers/friends/etc., then the social reach of the organization would be 60,000 individuals (e.g., 100×3×200=60,000). In this example, when the Admin submits a post, the post has the chance to be viewed by an audience of 60,000 people. The exemplary web analytics can also be provided to the subscribers, e.g., in a limited manner determined by the Admin. For example, the subscribers can be presented with selected information such as the amount of views and clicks as it pertains to the audience of the subscriber's social network that viewed the post(s).

For example, the web analytics can include information on aggregate views of content based on the viewer's selection of linked content (e.g., viewer clicks of links in post). In some implementations, for example, the disclosed system can compile information about the viewer of the selected linked content, e.g., including but not limited to, the viewer's location or region (e.g., based on IP address or GPS information from a mobile application), or the demographic information provided to the social network, etc.

The exemplary online tools of the disclosed systems and methods can include variable content tags (e.g., referred to as VC Tags) structured in the post that the Admin creates to provide the content message. These VC Tags can allow the posts to be personalized specifically to each subscriber, thereby allowing each post to be uniquely different. For example, a VC Tag might appear in the text comprising the post as follows: [p:name]. In this example, the exemplary online tools can utilize the VC Tag [p:name] to present each subscriber's name in the post that is presented to the audience of individuals of the subscriber's authorized social networks. For example, an exemplary post might read: “Contact [p:name] to learn more about our special product line.” The VC Tag [p:name] can be personalized automatically to each subscriber. In addition, the exemplary online tools of the disclosed systems and methods can also include a VC Tag that is an HTML link, e.g., such that the link would contain an ID that ties to the subscriber, so that the linked HTML page it is referencing can be personalized (e.g., including automatically personalized) with the subscriber's information, e.g., as the HTML page can also contain VC Tags. For example, an exemplary post might read: “Contact [p:name] to learn more about our special product line by checking out this site [p:link]”. In such examples, when an individual (e.g., of the audience) clicks the link, the disclosed system can provide a unique and personalized HTML page that also contains additional VC Tags that are also essentially personalized to the individual viewer based on the subscriber's provided information. In some implementations, for example, the HTML page can also contain a form (e.g., such as an online form, submitted over the Internet) that the individual viewer can fill out, e.g., in which the filled-out information of the form can be routed to the corresponding subscriber.

In an illustrative example, a subscriber can include a real estate agent representing a brand name real estate agency or company. The real estate agent can use the exemplary online tools to authorize his/her real estate company access to his/her social network on the subscriber's selected social media groups. An admin from the real estate company is then enabled to post content on the behalf of the real estate agent, e.g., such as featured real estate listings in his/her region or locale. The posts can provide information about the listing, contain VC Tags that personalize it to each subscriber, and also contain a link to an HTML page that provides additional information on the listing. The HTML page can contain personalized contact information to reach the agent through the VC Tags and a contact form for the visitor to fill out to request the agent to contact them.

In some aspects, a method for providing personalized online marketing information includes a process to receive content information generated by an administrator user of an entity. The method includes a process to receive user information about a subscriber user affiliated with the entity, in which the subscriber user is a registered user of one or more social networks via social media sites that provides an online linkage of the subscriber user with individuals within the social network. The method includes a process to receive an authorization by the subscriber user to permit access of the computer system to one or more authorized social networks designated by the subscriber user. The method includes a process to produce an individualized message capable of being displayed to the individuals of the one or more authorized social networks on behalf of the subscriber user, in which the individualized message includes the content information and at least one virtual content tag that corresponds to the user information of the corresponding subscriber user.

Implementations of the method can include one or more of the following exemplary features and can be implemented by a computer system, as described herein. In some implementations, for example, the method can include a process to deliver the individualized message to a host system facilitating the social media site using an account of the registered user corresponding to the subscriber user. In some implementations, for example, the method can include a process to receive a time by the administrator user for delivery of the individualized message to the host system facilitating the social media site. In some implementations, for example, the method can include a process to determine a quantitative value of the number of individuals that can view a delivered individualized message on the one or more authorized social networks on behalf of the subscriber user; and to generate a report including the quantitative value. In some implementations, for example, the method can include a process to generate a website including at least some of the user information of the subscriber user, in which the individualized message includes a personalized link to the website using a virtual content tag corresponding to the subscriber user. In some implementations, for example, the method can include a process to monitor activity of the website to determine a number of views by viewers that view the website via the personalized link in the individualized message. For example, the process to monitor the activity of the website can include collecting information about the viewers that view the website via the personalized link in the individualized message. In some implementations, for example, the method can include a process to generate a report including the number of views. In some implementations, for example, the method can include a process to receive a selection of at least one of (i) subscriber users to provide the individualized message, (ii) authorized social networks to provide the individualized message, or (iii) authorized social networks among the elected subscriber users to provide the individualized message.

For example, in the method, the entity can include a business or a group representing a brand, and for example, the subscriber user can be affiliated with the entity by employment, membership, or other type affiliation with the entity. For example, in the method, the user information can include at least one of the subscriber user's name, title, company, address, contact information, or location, or products or services produced or provided by the subscriber user.

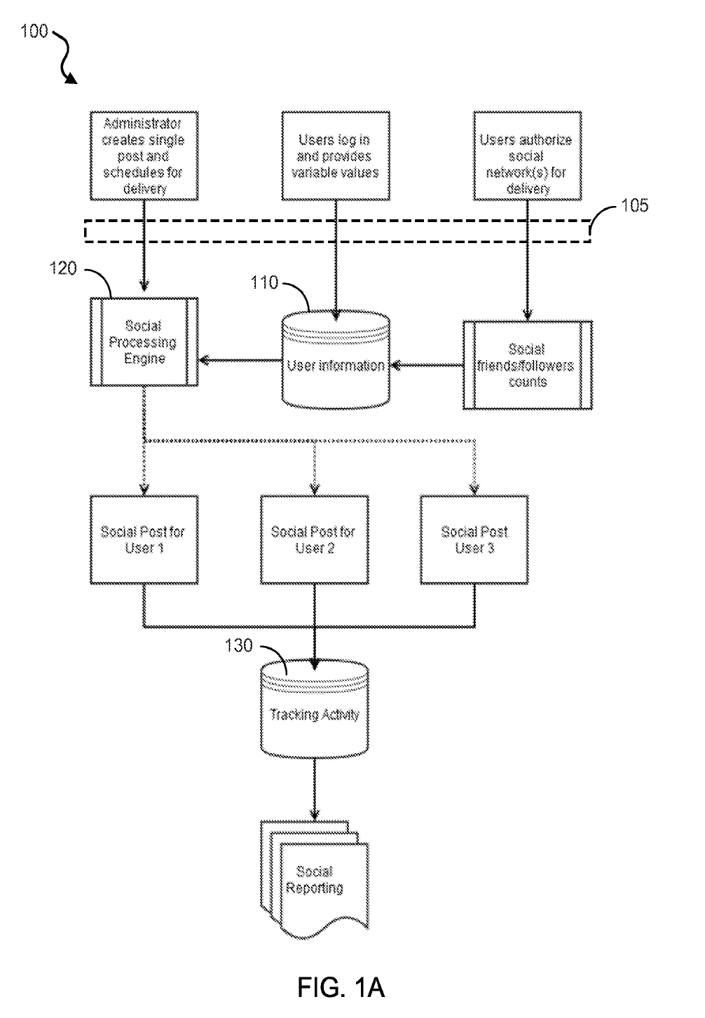

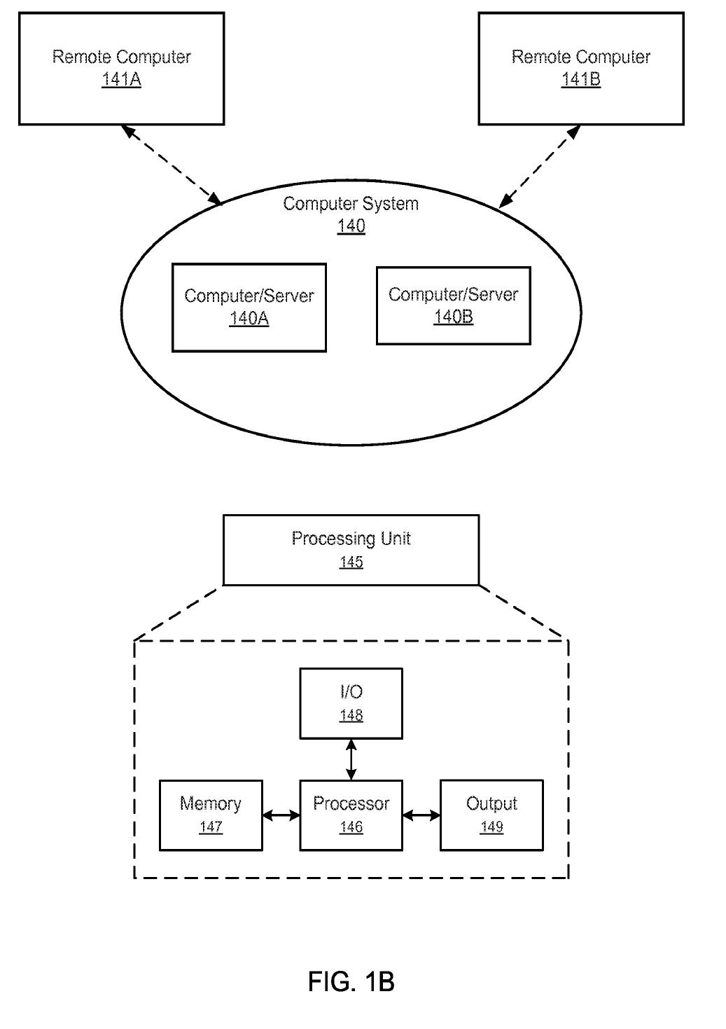

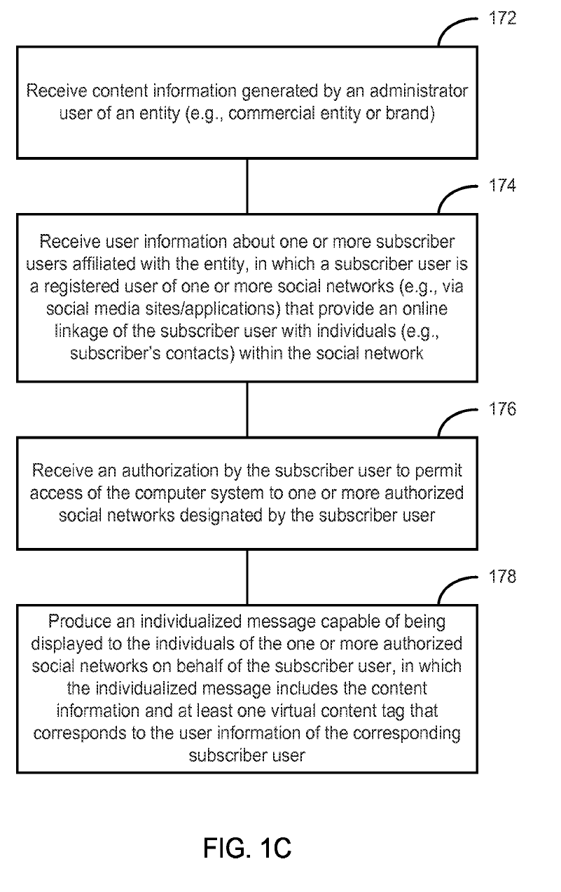

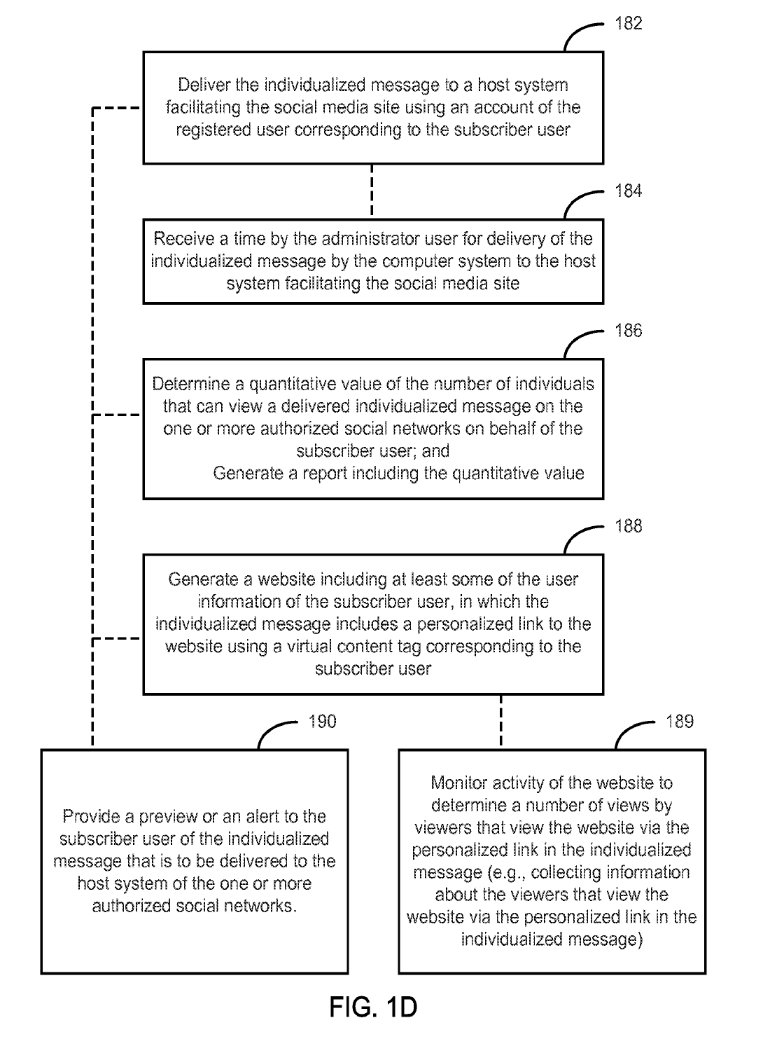

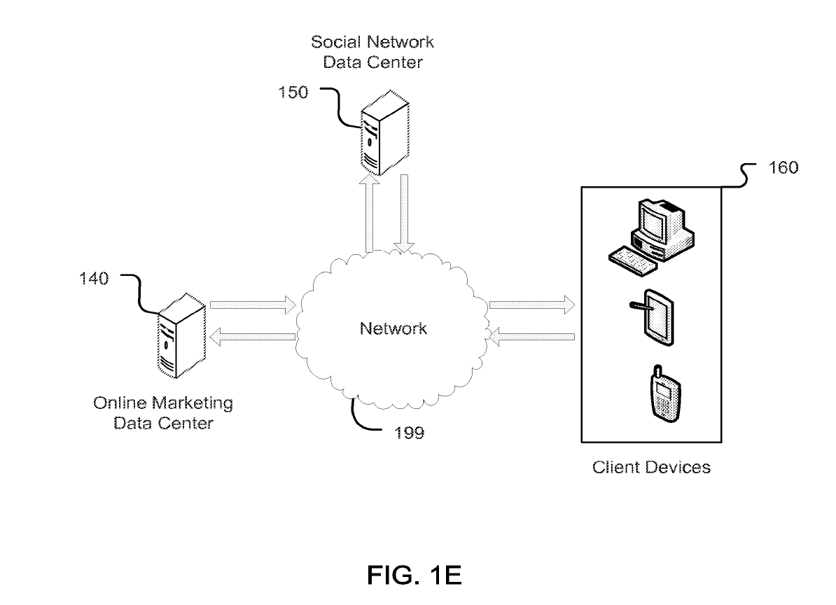

FIG. 1A shows a process diagram of an exemplary online marketing tool 100 of the disclosed technology. As shown in the diagram, the online marketing tool 100 includes a database 110 of user information of subscriber users and their authorized social networks. Using a web portal or software widget 105 of the online marketing tool 100, the subscriber users can provide subscriber-unique information that is stored in the database 110 and able to be used as variable values that the online marketing tool 100 can process to produce a post having Admin-created content and the variable values to display such content with subscriber-unique information. The subscriber users, using the web portal or software widget 105 of the online marketing tool 100 can authorize their social networks that they determine to allow the online marketing tool 100 to post the content posts on their behalf. For example, the content posts can be deployed by the online marketing tool 100 on a plurality of authorized social networks across a plurality of different subscribers that appears to viewers to be posted by the specific subscriber that they are connected to on that social network. The online marketing tool 100 includes a social processing engine 120 that receives the content post created by an Administrator user. Using the web portal or software widget 105 of the online marketing tool 100, the Admin can create the content of a post, select the authorized social media channels of subscribers to deliver the post, and schedule the time when the post will be delivered via the social processing engine 120 to the selected social media channels on behalf of the subscriber users. The online marketing tool 100 includes a database 130 of monitored activity by individuals connected to the subscriber users on their authorized social networks. The online marketing tool 100 can provide analytics including tracking of post deployment and viewer access to generate statistics and reports. For example, the reports can include real-time aggregated counts of prospective viewers and current views (e.g., click activity) by the viewers across each authorized social network for each selected subscriber users.

FIG. 1B shows an exemplary computer system 140 for implementing the disclosed online information creation and distribution methods and tools, e.g. such as the exemplary online marketing tool 100. The exemplary computation or computer system can include one or more computers (e.g., servers) 140A, 140B that are in communication with remote computers, servers or computing devices 141A, 141B. For example, the remote computers or computing devices 141A, 141B can include desktop and laptop computers, tablets, smartphone devices, and wearable communication devices (e.g., smartglasses, smartwatch, etc.). In some implementations, the one or more computers 140A, 140B can be included in a network with the remote computers 141A, 141B and in communication with other computers via the Internet.

The one or more computers 140A, 140B of the computer system 140 include one or more processing units 145. The processing unit 145 can include a processor 146 to process data that can be in communication with a memory 147 to store data. The memory 147 can store the data and information that can be used to implement an exemplary online marketing method and that can be generated from an exemplary algorithm and model. For example, the memory 147 can include processor-executable code, which when executed by the processor 146, configures the one or more computers 140A, 140B to perform various operations, such as receiving information, commands, and/or data, processing information and data, and transmitting or providing information/data to another entity or to a user. The memory 147 can store other information and data, such as instructions, software, values, images, and other data processed or referenced by the processor. Various types of Random Access Memory (RAM) devices, Read Only Memory (ROM) devices, Flash Memory devices, and other suitable storage media can be used to implement storage functions of the memory 147.

The processing unit 145 can further include an input/output (IO) unit 148, and/or an output unit 149. The input/output (IO) unit 148 is in communication with the processor 146 and provides wired and/or wireless interfaces compatible with typical data communication standards for communication of the computer with other computers and computer systems, or external interfaces, sources of data storage, or display devices, among others. For example, the IO unit 148 can provide wired or wireless communications using one or more of the following communications standards, e.g., including, but not limited to, Universal Serial Bus (USB), IEEE 1394 (FireWire), Bluetooth, IEEE 802.11, Wireless Local Area Network (WLAN), Wireless Personal Area Network (WPAN), Wireless Wide Area Network (WWAN), WiMAX, IEEE 802.16 (Worldwide Interoperability for Microwave Access (WiMAX)), 3G4G/LTE cellular communication methods, and parallel interfaces, among others. The output unit 149 can be used to exhibit data implemented by the processing unit 145. For example, the output unit 149 can include various types of display, speaker, or printing interfaces to implement or present the data output, e.g., including, but not limited to, a cathode ray tube (CRT), light emitting diode (LED), or liquid crystal display (LCD) monitor or screen as a visual display to implement the output unit 149; and/or various types of audio signal transducer apparatuses to implement the output unit 149. The output unit can exhibit the data and information, as well as store the data and information used to implement an exemplary process of the disclosed methods and from an implemented process.

FIG. 1C shows a block diagram of an exemplary method to provide personalized content information (e.g., online marketing information) from a subscriber to multiple contacts across one or more social network platforms. The method includes a process 172 to receive content information generated by an administrator user of an entity, e.g., such as a commercial entity or brand. The method includes a process 174 to receive user information about a subscriber user affiliated with the entity, in which the subscriber user is a registered user of one or more social networks (e.g., via social media websites or software applications) that provide an online linkage of the subscriber user with individuals (e.g., the subscriber's contacts, connections, friends, etc.) within the social network. The method includes a process 176 to receive an authorization by the subscriber user to permit access of the computer system to one or more authorized social networks designated by the subscriber user. The method includes a process 178 to produce an individualized message capable of being displayed to the individuals of the one or more authorized social networks on behalf of the subscriber user, in which the individualized message includes the content information and at least one virtual content tag that corresponds to the user information of the corresponding subscriber user.

FIG. 1D shows a diagram of exemplary processes of the method of FIG. 1C. For example, in some implementations of the method, the method can further include a process 182 to deliver the individualized message to a host system facilitating the social media site using an account of the registered user corresponding to the subscriber user. For example, in some implementations of the method, the method can include a process 184 to receive a time (e.g. a designated time) by the administrator user for the delivery of the individualized message by the computer system to the host system facilitating the social media site. For example, in some implementations of the method, the method can include a process 186 to determine a quantitative value of the number of individuals that can view a delivered individualized message on the one or more authorized social networks on behalf of the subscriber user; and to generate a report including the quantitative value. For example, in some implementations of the method, the method can include a process 188 to generate a website including at least some of the user information of the subscriber user, in which the individualized message includes a personalized link to the website using a virtual content tag corresponding to the subscriber user. For example, in some implementations of the method, the method can include a process 189 to monitor activity of the website to determine a number of views by viewers that view the website via the personalized link in the individualized message (e.g., collecting information about the viewers that view the website via the personalized link in the individualized message). For example, in some implementations of the method, the method can include a process to receive a selection of (i) subscriber users to provide the individualized message, (ii) authorized social networks to provide the individualized message, and/or (iii) authorized social networks among the elected subscriber users to provide the individualized message. In some implementations of the method, for example, the method can include a process 190 to provide a preview or an alert to the subscriber user of the produced individualized message to be delivered to the host system of the one or more authorized social networks (e.g., for distribution to the subscriber user's contacts on the respective social network, e.g., which can include only pre-authorized contacts designated by the subscriber user for the respective social network). For example, implementation of the process 190 allows the subscriber user to edit or modify the individualized message (scheduled for delivery), or do nothing and let the computer system automatically deliver the individualized message on the subscriber user's behalf.

FIG. 1E shows an example of a communication network 199 (e.g., the Internet) for implementing the disclosed online information creation and distribution methods and tools across one or more social network platforms subscribed to by individual users (e.g., via client devices). As shown in the diagram, the computer system 140 can operate as an online marketing data center in communication with individual users via their client devices 160 and the social network data centers 150 (e.g., servers of the respective online social network platforms). The computer system 140 can implement the processes shown in FIG. 1C and/or FIG. 1D.

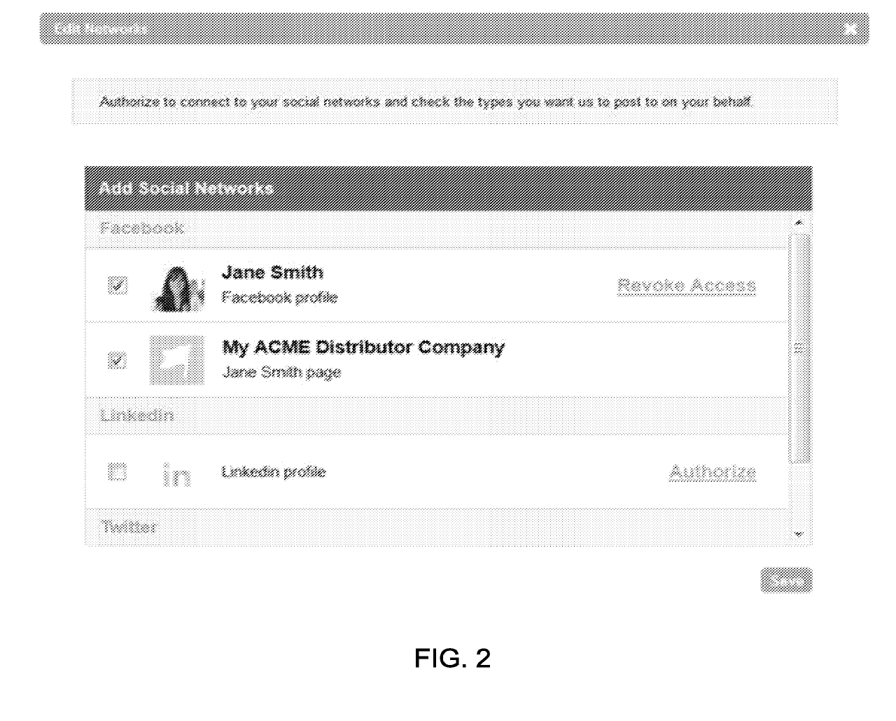

An implementation of the online marketing tool of the disclosed technology can include the following example. To help illustrate this example, FIGS. 2-9 show exemplary visual displays of an interactive user interface of the exemplary online marketing tool presented to a subscriber and/or Admin using a web portal.

Using the interactive user interface of the exemplary online marketing tool, a subscriber user can log in to the system platform providing the exemplary online marketing tool, e.g. using a web portal, and provide credentials to authorize one or more of the subscriber's social media accounts to allow the system platform to post content (e.g., generated and/or provided by an Admin of a brand or other content source) on the authorized social media sites on the subscriber's behalf, e.g., as if the subscriber posted the content directly himself/herself. On a controlled and/or regular basis, the system platform will determine the social reach of the subscriber user (e.g., calculate current followers, friends, and connections of the subscriber user to individuals of his/her social network for each of the subscriber user's authenticated social networks).

FIG. 2 shows an exemplary display screen of an interactive user interface of the exemplary online marketing tool showing a subscriber user's social networks for authorization to allow the content posts. In this exemplary display, the user interface presents an organized list of social networks the subscriber has let known to the system platform. The display of the interactive user interface shows the authorization status each known social network, e.g., if the social media site is authorized, and if so, providing a link or button to revoke access or authorization to that social media network. In some instances, a social media site may include multiple social networks, e.g., such as a personal social network of the subscriber user, and a business social network of the subscriber user. The interactive social network can provide the capability for the subscriber to authorize at least some of his/her social networks within a single social media entity.

Using the interactive user interface of the exemplary online marketing tool, the subscriber user can also provide (e.g., input and/or edit) information and attributes about himself/herself that are relevant to marketing materials that will be deployed for the subscriber user on the subscriber's authorized social networks.

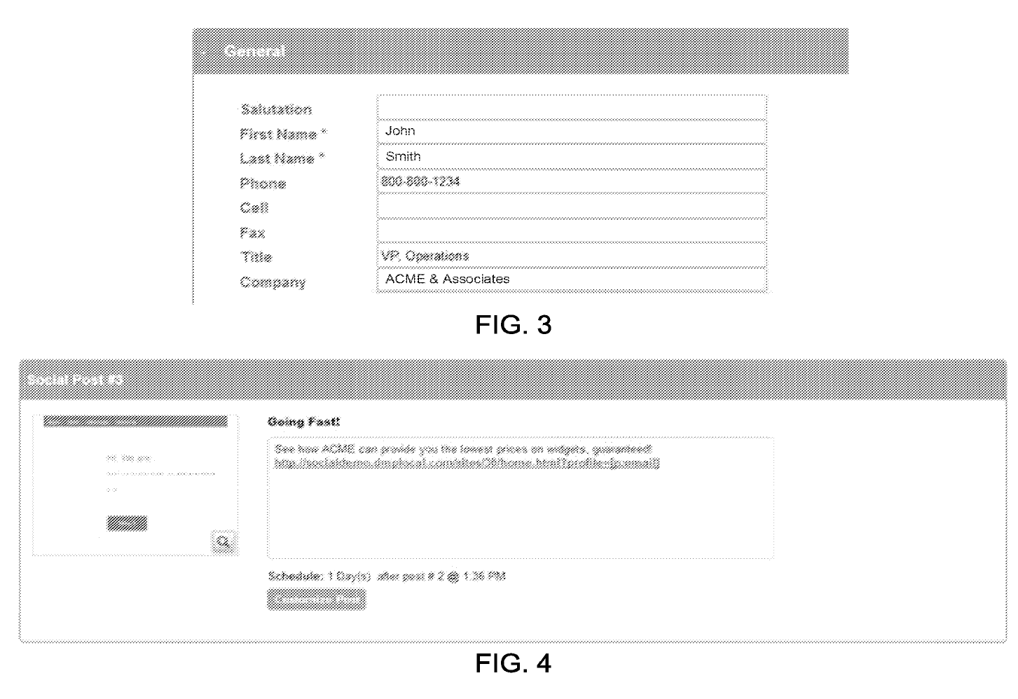

FIG. 3 shows an exemplary display screen of an interactive user interface of the exemplary online marketing tool showing a subscriber user's information that the subscriber user can provide to the system platform. For example, the information may include, and is not limited to, the subscriber's name, title, company, address, contact information, location, products and/or services, etc. This information can be used when the system platform processes the social network post and performs information replacement that inserts such personalized information into the post, e.g., using VC Tag(s).

The administrator user can use the interactive user interface of the exemplary online marketing tool to create a post and configure its deployment. To generate and designate deployment of a post, for example, the administrator user can log in and create content information (e.g., such as an advertisement, a message, a question or query or other type) to post on selected subscriber's authorized social networks. In some implementations, the interactive user interface enables the administrator user to select which authorized social networks to restrict the content from being posted. For example, the content information formed in the post by the administrator user includes variable content and any relevant links. Variable data will be represented by a variable content tag (VC Tag). In some implementations, for example, the posts can include image files, audio files, video files, and/or other media as part of the post deployed on the authorized social media sites.

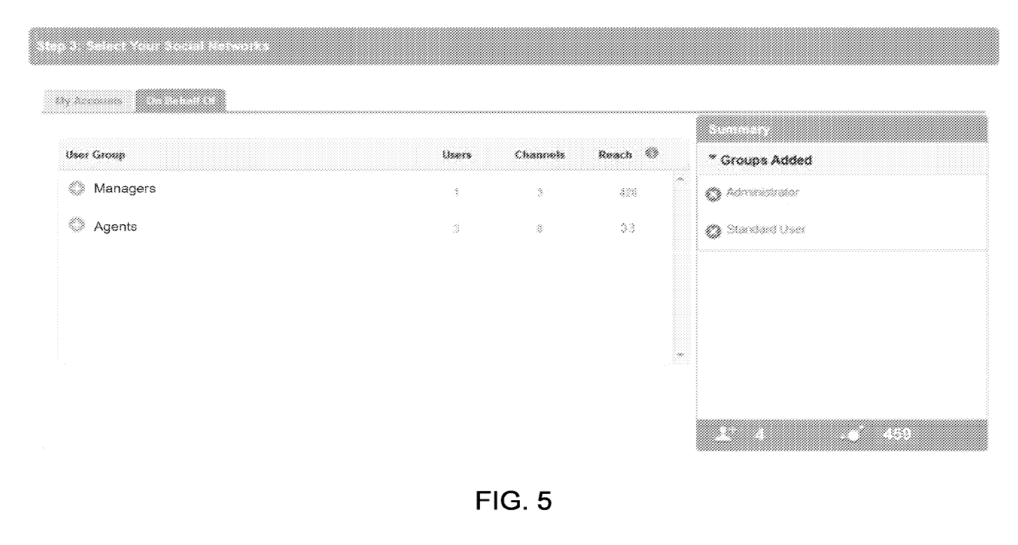

FIG. 4 shows an exemplary display screen of an interactive user interface of the exemplary online marketing tool showing an administrator user's created content post including VC Tags and web links. In this example, the post includes a title or subject (e.g., “Going Fast!”), textual information (e.g., “See how ACME can provide you the lowest prices on widgets, guaranteed!”) and a web link that would direct the audience (e.g., individuals of the subscriber's authorized social network) to the website corresponding to the link. For example, the web link itself can be personalized using the VC Tag, as depicted in this example where a portion of the actual web link includes an email address that can be substituted by the subscriber's email address using the exemplary VC Tag: [p:email]. Thus, the subscriber user's email address will be dynamically inserted in the web link of this exemplary post upon deployment to the authorized social media site(s). The user interface can assign a unique post identification (ID) to each post an administrator user creates. The exemplary online marketing tool enables an administrator user to schedule the deployment (posting) of the post at a specified date and time to be presented (e.g., posted, tweeted, delivered, presented) to the authorized social networks. For example, the specified date and time can be an absolute date and time (e.g., calendar date and time), as well as a relative date and/or time (e.g., such as 1 day after post #2 @ 1:36 pm).

The exemplary online marketing tool can generate a thumbnail of the post or a portion of the content of the post, as depicted in the exemplary display screen of the interactive user interface shown in FIG. 4. In the example shown in FIG. 4, the thumbnail displays a preview of the linked website that the web link would direct a viewer upon selection (e.g., user click). This can allow the administrator user to preview the page the post is linking to. Similarly, the thumbnail can also show how the post would appear to a viewer on the various authorized social media sites.

Using the interactive user interface of the exemplary online marketing tool, the administrator can also select one or more groups of one or more subscribers to deploy a post on behalf of the subscribers. By adding groups to the exemplary deployment list, the system platform can provide a summary of how many social networks and individuals can be reached with the post, e.g., displayed by the exemplary interactive user interface.

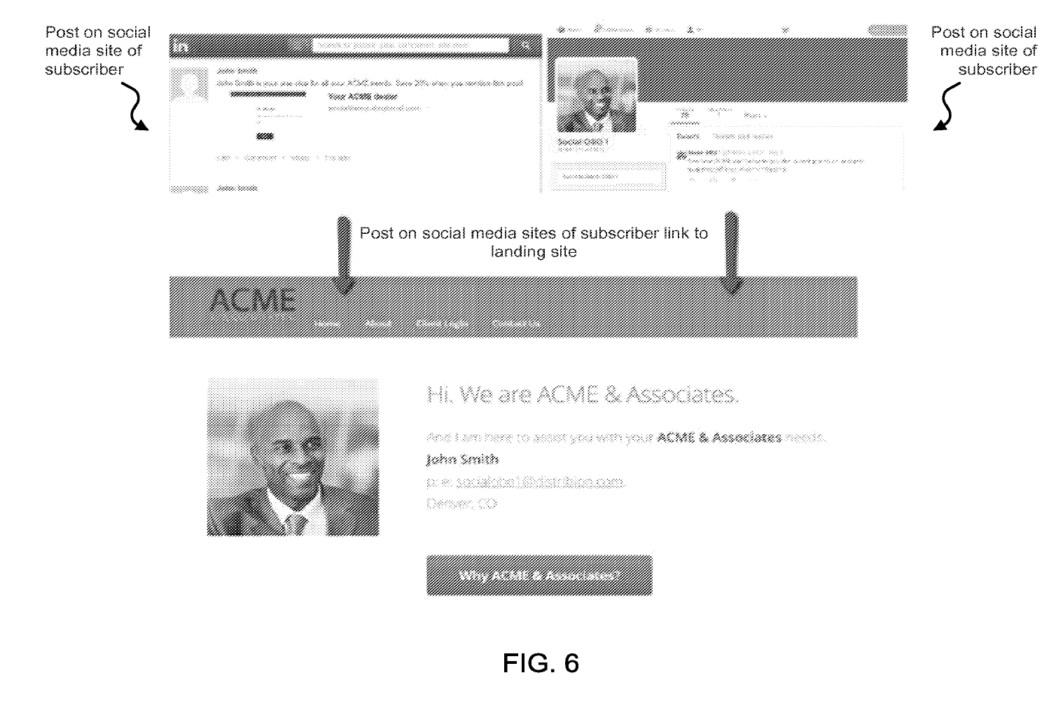

FIG. 5 shows an exemplary display screen of an interactive user interface of the exemplary online marketing tool showing listings of user groups including selected subscribers and quantitative data on the number of social networks and individuals that may view the post. In this example, the display includes various tabs that the administrator user can select to access different accounts and/or different user group lists. For example, an exemplary user group listing shown in FIG. 5 depicts a Managers user group comprising one user (e.g., subscribers) with three authorized social networks (e.g., channels) having a total of 426 friends/followers/connections across the three channels. The exemplary user group listing also includes an Agents user group comprising three users (e.g., subscribers) having a total of eight channels and 33 friends/followers/connections across the eight channels. In this example, the current social reach across the user groups is 459, which is summarized in a portion of the exemplary user interface display proximate the user group listing. Also, the exemplary online marketing tool enables the administrator user to post to his/her own authorized social networks, e.g., which can be selected for authorization on the exemplary “My Accounts” tab of the exemplary interactive user interface shown in FIG. 5.

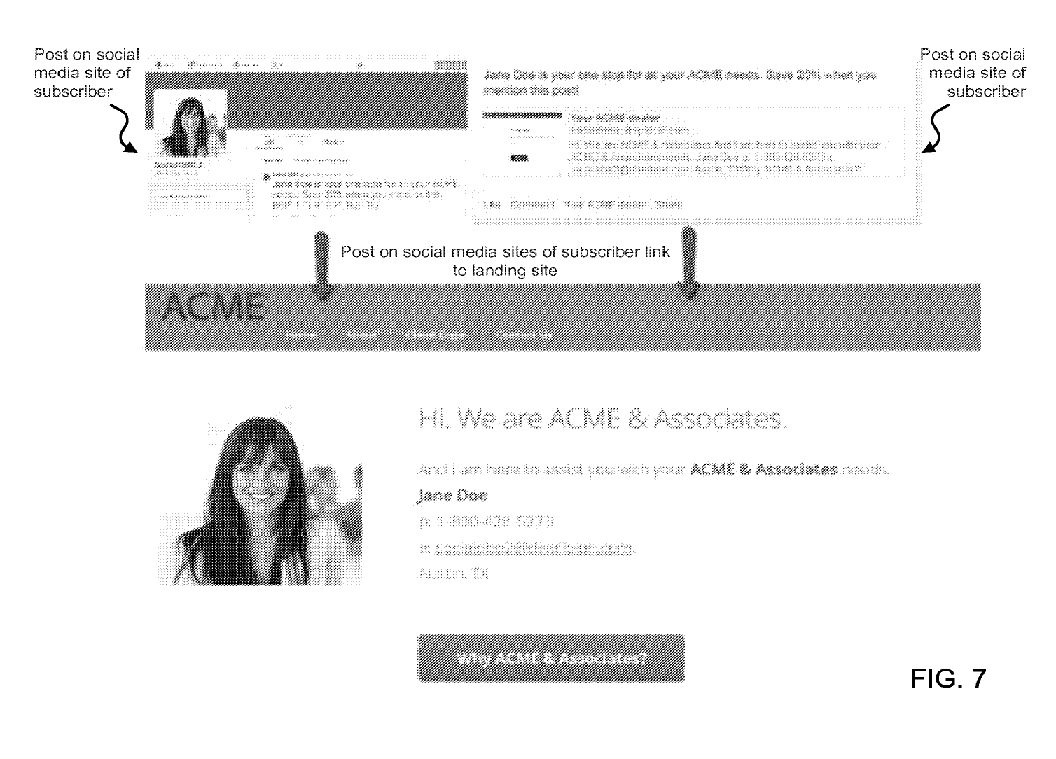

Based on the designated date and time of deployment, the system platform deploys each post to the authorized social networks of the subscriber(s), e.g., where each post is personalized with the variable content of the subscriber, like that shown in FIG. 4. In the following examples shown in FIGS. 6 and 7, each subscriber user has a unique landing page which is linked to the social post.

FIGS. 6 and 7 show exemplary display screens of an interactive user interface of the exemplary online marketing tool showing a subscriber user's landing page. As shown in these examples, the exemplary posts to multiple social media sites of a subscriber (shown in the top left and top right portions of FIGS. 6 and 7), which are accessible to the social network of the subscriber, include personalized links to the respective subscriber's personal landing web sites (shown in the bottom portions of FIGS. 6 and 7).

The exemplary online marketing tool can provide web analytics including tracking statistics and reports that present the social reach of an entity or organization. For example, the report can display the number of people that can potentially view a post (e.g., the social reach) across each social media site on all authorized networks, e.g., showing the total number of followers, friends, connections, etc. across all subscriber users that have authorized their networks to receive content from the centralized source. This allows the administrator user to determine how large the total audience is that can potentially view the post.

Also, as viewers click on a link deployed in a subscriber user's social post, the system tracks all click activity of the viewers. The exemplary online marketing tool can use the tracking to analyze information associated with the number of possible views of each post and the number of viewers accessing information in the post, e.g., by clicking a link. The analyzed information can be used to generate statistics and reports that illustrate the social reach and access of the content in the posts.

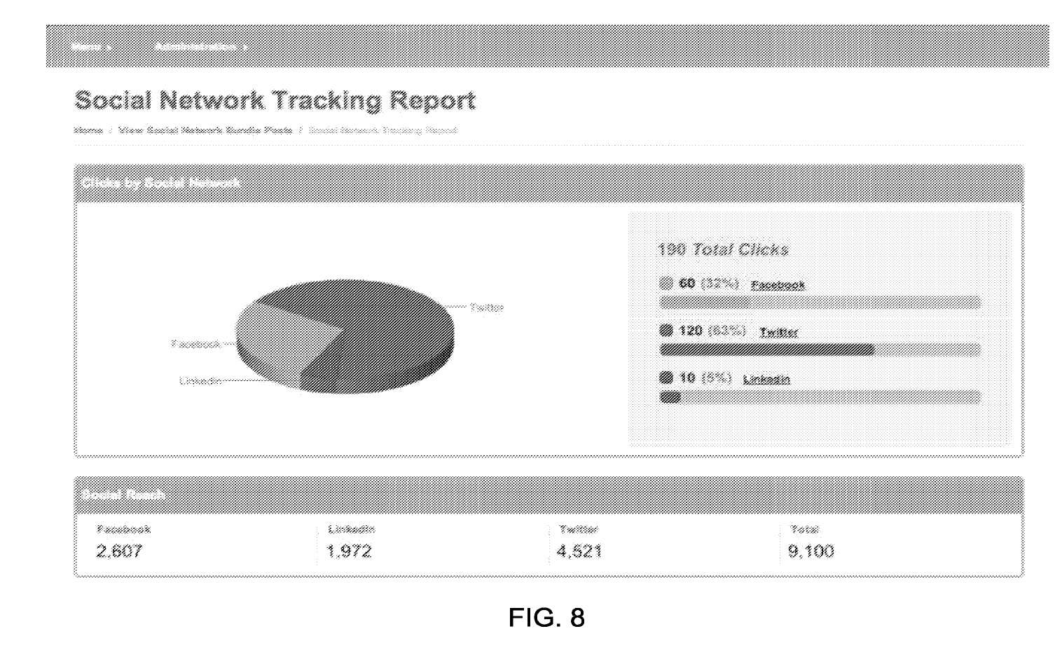

FIG. 8 shows an exemplary display screen of an interactive user interface of the exemplary online marketing tool showing an example of a generated report of viewer access across authorized social media channels. For example, as shown in the top portion of the exemplary interactive user interface (e.g., “Clicks by Social Network”), the analyzed activity of the viewers who viewed the post and clicked the subscriber-personalized link in the post is graphically presented to the Admin using the interactive user interface. The exemplary report includes the click activity of a post or posts by viewers across each authorized social media channel for each selected subscriber users, e.g., providing an aggregated view for the Admin for each post. Also, as shown in the bottom portion of the exemplary interactive user interface (e.g., “Social Reach”), the analyzed quantitative data on the amount of aggregated individuals within the authorized social networks that can view the post or posts are summarized for each social network site.

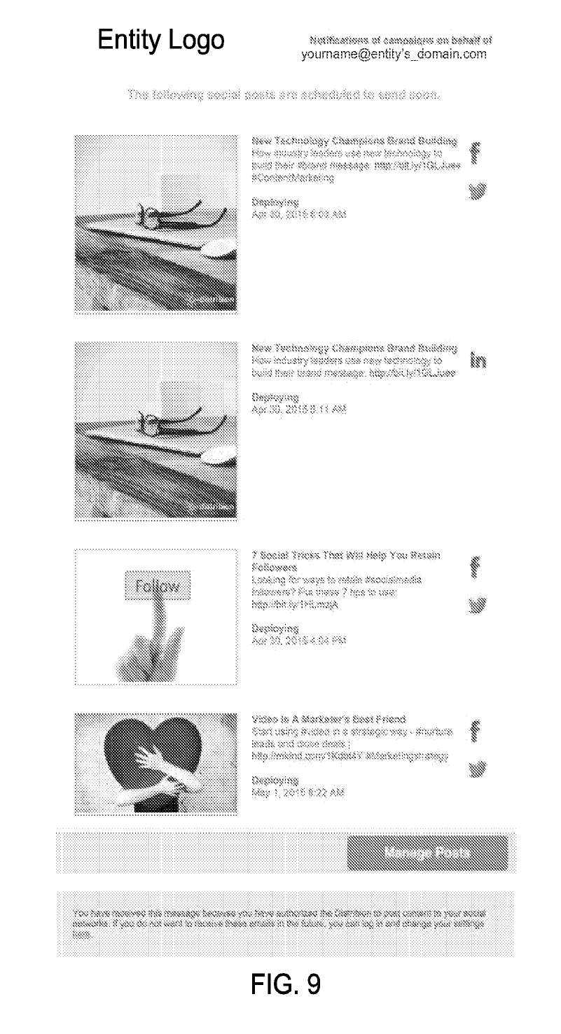

FIG. 9 shows an exemplary display screen of an example preview to a subscriber user depicting individualized messages to be delivered to the user's connections on authorized social networks. As depicted by the interactive user interface display in FIG. 9, the preview messages (e.g., to be distributed to contacts on multiple social networks) is branded to represent the entity who is initiating the social network posts on behalf of their users. For example, the exemplary preview of the individualized message can include the content title and message body information, indicator(s) of which social network platforms that the individualized messages will be distributed, and the time at which the individualized message will be automatically deployed, e.g., should the subscriber use not modify or cancel the individualized message delivery. As depicted in the example display screen, the user interface can include a ‘manage post’ or modify button to allow the user to edit the content information, the designated social networks and/or recipients, and the scheduled time of automatic delivery.

### EXAMPLES

The following examples are illustrative of several embodiments of the present technology. Other exemplary embodiments of the present technology may be presented prior to the following listed examples, or after the following listed examples.

In one example of the present technology (example 1), a method for providing personalized online marketing information includes receiving, at a computer system of one or more computers, content information generated by an administrator user of an entity; receiving, at the computer system, user information about a subscriber user affiliated with the entity, in which the subscriber user is a registered user of one or more social networks via social media sites that provides an online linkage of the subscriber user with individuals within the social network; receiving, at the computer system, an authorization by the subscriber user to permit access of the computer system to one or more authorized social networks designated by the subscriber user; and producing, by the computer system, an individualized message capable of being displayed to the individuals of the one or more authorized social networks on behalf of the subscriber user, in which the individualized message includes the content information and at least one virtual content tag that corresponds to the user information of the corresponding subscriber user.

Example 2 includes the method of example 1, further including delivering, by the computer system, the individualized message to a host system facilitating the social media site using an account of the registered user corresponding to the subscriber user.

Example 3 includes the method of example 2, further including receiving, at the computer system, a time by the administrator user for delivery of the individualized message by the computer system to the host system facilitating the social media site.

Example 4 includes the method of example 2, further including determining, by the computer system, a quantitative value of the number of individuals that can view a delivered individualized message on the one or more authorized social networks on behalf of the subscriber user; and generating a report including the quantitative value.

Example 5 includes the method of example 2, further including generating, by the computer system, a website including at least some of the user information of the subscriber user, in which the individualized message includes a personalized link to the website using a virtual content tag corresponding to the subscriber user.

Example 6 includes the method of example 5, further including monitoring, by the computer system, activity of the website to determine a number of views by viewers that view the website via the personalized link in the individualized message.

Example 7 includes the method of example 6, in which the monitoring includes collecting information about the viewers that view the website via the personalized link in the individualized message.

Example 8 includes the method of example 6, further including generating a report including the number of views.

Example 9 includes the method of example 2, further including providing, by the computer system, a preview or an alert to the subscriber user of the produced individualized message prior to the delivering of the individualized message to the host system.

Example 10 includes the method of example 1, further including receiving, at the computer system, a list of pre-authorized contacts by the subscriber user for the one or more authorized social networks.

Example 11 includes the method of example 1, further including receiving, at the computer system, a selection of at least one of (i) subscriber users to provide the individualized message, (ii) authorized social networks to provide the individualized message, or (iii) authorized social networks among the elected subscriber users to provide the individualized message.

Example 12 includes the method of example 1, in which the entity includes a business or a group representing a brand.

Example 13 includes the method of example 11, in which the subscriber user is affiliated with the entity by at least one of employment or membership with the entity.

Example 14 includes the method of example 1, in which the user information includes at least one of the subscriber user's name, title, company, address, contact information, or location, or products or services produced or provided by the subscriber user.

In one example of the present technology (example 15), a system for providing online marketing includes one or more computers in communication with a plurality of remote computing devices operated by administrator users and by subscriber users of a social network via a communication network or link, in which an administrator user represents an entity, and a subscriber user is affiliated with the entity and is a registered user of one or more social networks via social media sites that link the subscriber user with individuals within the social network. The system is configured to receive (i) content information generated by the administrator user, (ii) user information about the subscriber user, and (iii) authorization by the subscriber user permitting access to one or more of the subscriber user's social media site accounts designated by the subscriber user. The system is configured to produce an individualized message capable of being displayed to the individuals of the subscriber user's authorized social networks on behalf of the subscriber user. The individualized message includes the content information and at least one virtual content tag that corresponds to the user information of the corresponding subscriber user.

Example 16 includes the system of example 15, in which the system is configured to deliver the produced individualized message to a host system facilitating the social media site using an account of the registered user corresponding to the subscriber user.

Example 17 includes the system of example 16, in which the system is configured to receive a delivery time by the administrator user for delivery of the individualized message to the host system facilitating the social media site.

Example 18 includes the system of example 16, in which the system is configured to determine a quantitative value of the number of the individuals that can view the delivered individualized message on the one or more authorized social networks on behalf of the subscriber user.

Example 19 includes the system of example 15, in which the individualized message includes a personalized link to a website using a virtual content tag corresponding to the subscriber user, and in which the system is configured to generate content for the website using at least some of the user information of the subscriber user.

Example 20 includes the system of example 19, in which the system is configured to monitor activity of the website to determine a number of views by viewers that view the website via the personalized link in the individualized message.

Example 21 includes the system of example 20, in which the system is configured to collect information about the viewers that view the website via the personalized link in the individualized message.

In one example of the present technology (example 22), a method for distributing personalized content across social network platforms, includes generating, at a computer system of one or more computers, content information to be distributed to a plurality of recipients across one or more social networks that provide an online linkage of registered individuals within the social network; obtaining, at the computer system, user information from a user who is a subscriber user affiliated with the entity and is a registered user of the one or more social networks; receiving, at the computer system, an authorization by the user to permit access of the computer system to pre-authorized connections among the registered users of the one or more authorized social networks designated by the user; producing, by the computer system, an personalized message capable of being displayed to pre-authorized connections of the one or more authorized social networks on behalf of the user, in which the personalized message includes the content information and at least one virtual content tag that corresponds to the user information of the user; and delivering, by the computer system, the personalized message to a host system facilitating the social media site using an account of the registered user corresponding to the subscriber user.

Example 23 includes the method of example 22, in which the generating the content information includes receiving at least some of the content information from a client computer in communication with the computer system.

Example 24 includes the method of example 23, in which the content information is generated by an administrator user of an entity.

Example 25 includes the method of example 22, in which the user information is obtained by the computer system from one or more remote client computers of the user, in which the remote client computers include one or more of a desktop computer, a laptop computer, a smartphone, a tablet, or a wearable communication device.

Example 26 includes the method of example 22, further including receiving, at the computer system, a time by the administrator user for delivery of the personalized message by the computer system to the host system facilitating the social media site.

Example 27 includes the method of example 22, further including determining, by the computer system, a quantitative value of the number of individuals that can view a delivered personalized message on the one or more authorized social networks on behalf of the user; and generating a report including the quantitative value.

Example 28 includes the method of example 22, further including generating, by the computer system, a website including at least some of the user information of the user, in which the personalized message includes a link to the website using a virtual content tag corresponding to the user.

Example 29 includes the method of example 28, further including monitoring, by the computer system, activity of the website to determine a number of views by viewers that view the website via the link in the personalized message.

Example 30 includes the method of example 29, in which the monitoring includes collecting information about the viewers that view the website via the link in the personalized message.

Example 31 includes the method of example 30, further including generating a report including the number of views.

Example 32 includes the method of example 22, further including providing, by the computer system, a preview or an alert to the user of the produced personalized message prior to the delivering of the personalized message to the host system.

Example 33 includes the method of example 22, further including receiving, at the computer system, a list of pre-authorized contacts by the user for the one or more authorized social networks.

In one example of the present technology (example 34), a method for distributing personalized content to contacts on social network platforms includes, at a computer system of one or more computers, generating a master message including content information pertaining to an entity to form a distribution message to be distributed on behalf of a subscriber user to a plurality of recipients across one or more social networks, in which the master message is generated to include (i) one or both of text and graphics to convey the content information and (ii) dynamic tags that maps to personalized information associated with the subscriber user into the distribution message, thereby allowing the distribution message to be uniquely different for each subscriber user, and in which the plurality of recipients include registered users of the one or more social networks having a connection with the subscriber user on the respective social network; receiving, at the computer system, a delivery time of the distribution message; obtaining, at the computer system, the personalized information associated with the subscriber user, in which the subscriber user is affiliated with the entity and is a registered user of the one or more social networks; receiving, at the computer system, an authorization by the subscriber user to permit the computer system access to authorized social networks of the one or more social networks designated by the subscriber user; producing, by the computer system, the distribution message by inserting the corresponding personalized information for the dynamic tags in the master message such that the distribution message is capable of being displayed to the recipients on behalf of the subscriber user; and delivering, by the computer system, the distribution message at the delivery time to one or more host computer systems corresponding to the one or more social networks using an account of the subscriber user.

Example 35 includes the method of example 34, further including receiving, at the computer system, contact data including selections of the subscriber user's connections of the one or more authorized social networks on behalf of the user.

Example 36 includes the method of example 34, in which the personalized information includes at least one of the subscriber user's name, title, company, address, contact information, or location.

Example 37 includes the method of example 34, in which the content information includes information pertaining to the entity's products or services.

Example 38 includes the method of example 34, further including generating the content information by receiving at least some of the content information from a client computer in communication with the computer system.

Example 39 includes the method of example 38, in which the content information is generated by an administrator user of an entity.

Example 40 includes the method of example 34, in which the personalized information is obtained by the computer system from one or more remote client computers of the subscriber user, in which the remote client computers include one or more of a desktop computer, a laptop computer, a smartphone, a tablet, or a wearable communication device.

Example 41 includes the method of example 34, in which the delivery time of the distribution message is received from an administrator user affiliated with the entity.

Example 42 includes the method of example 34, further including determining, by the computer system, a quantitative value of the number of individuals that can view the delivered distribution message on the one or more authorized social networks on behalf of the subscriber user; and generating a report including the quantitative value.

Example 43 includes the method of example 34, further including generating, by the computer system, a website including at least some of the content information or the personalized information, in which the delivered distribution message includes a link to the website using a dynamic tag.

Example 44 includes the method of example 43, further including monitoring, by the computer system, activity of the website to determine a number of views by viewers that view the website via the link in the distribution message.

Example 45 includes the method of example 44, in which the monitoring includes collecting information about the viewers that view the website via the link in the distribution message.

Example 46 includes the method of example 44, further including generating a report including the number of views.

Example 47 includes the method of example 34, further including providing, by the computer system, a preview or an alert of the produced distribution message to the subscriber user prior to the delivering of the distribution message to the one or more host computer systems.

Example 48 includes the method of example 34, further including receiving, at the computer system, a list of pre-authorized connections by the subscriber user for delivery of the distribution message.

In one example of the present technology (example 49), a system for providing online marketing includes a network including one or more computers in communication with a plurality of remote computing devices operated by administrator users and by subscriber users of a social network, in which an administrator user represents an entity, and a subscriber user is affiliated with the entity and is a registered user of one or more social networks via social media sites that link the subscriber user with individuals within the social network. The system is configured to receive (i) content information generated by the administrator user, (ii) user information about the subscriber user, and (iii) authorization by the subscriber user permitting access to one or more of the subscriber user's social media site accounts designated by the subscriber user. The system is configured to produce an individualized message capable of being displayed to the individuals of the subscriber user's authorized social networks on behalf of the subscriber user. The individualized message includes the content information and at least one virtual content tag that corresponds to the user information of the corresponding subscriber user.

Example 50 includes the system of example 49, in which the system is configured to deliver the produced individualized message to a host system facilitating the social media site using an account of the registered user corresponding to the subscriber user.

Example 51 includes the system of example 50, in which the system is configured to receive a delivery time by the administrator user for delivery of the individualized message to the host system facilitating the social media site.

Example 52 includes the system of example 50, in which the system is configured to determine a quantitative value of the number of the individuals that can view the delivered individualized message on the one or more authorized social networks on behalf of the subscriber user.

Example 53 includes the system of example 49, in which the individualized message includes a personalized link to a website using a virtual content tag corresponding to the subscriber user, and in which the system is configured to generate content for the website using at least some of the user information of the subscriber user.

Example 54 includes the system of example 53, in which the system is configured to monitor activity of the website to determine a number of views by viewers that view the website via the personalized link in the individualized message.

Example 55 includes the system of example 54, in which the system is configured to collect information about the viewers that view the website via the personalized link in the individualized message.

Implementations of the subject matter and the functional operations described in this patent document can be implemented in various systems, digital electronic circuitry, or in computer software, firmware, or hardware, including the structures disclosed in this specification and their structural equivalents, or in combinations of one or more of them. Implementations of the subject matter described in this specification can be implemented as one or more computer program products, i.e., one or more modules of computer program instructions encoded on a tangible and non-transitory computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more of them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of nonvolatile memory, media and memory devices, including by way of example semiconductor memory devices, e.g., EPROM, EEPROM, and flash memory devices. The processor and the memory can be supplemented by, or incorporated in, special purpose logic circuitry.

While this patent document contains many specifics, these should not be construed as limitations on the scope of any invention or of what may be claimed, but rather as descriptions of features that may be specific to particular embodiments of particular inventions. Certain features that are described in this patent document in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the embodiments described in this patent document should not be understood as requiring such separation in all embodiments.

Only a few implementations and examples are described and other implementations, enhancements and variations can be made based on what is described and illustrated in this patent document.

What is claimed is:

1. A method for providing personalized online marketing information, comprising:
receiving, at a computer system of one or more computers, content information generated by an administrator user of an entity;
receiving, at the computer system, user information about a subscriber user affiliated with the entity, wherein the subscriber user is a registered user of one or more social networks via social media sites that provides an online linkage of the subscriber user with individuals within the social network;
receiving, at the computer system, an authorization by the subscriber user to permit access of the computer system to one or more authorized social networks designated by the subscriber user; and
producing, by the computer system, an individualized message capable of being displayed to the individuals of the one or more authorized social networks on behalf of the subscriber user, wherein the individualized message includes the content information and at least one virtual content tag that corresponds to the user information of the corresponding subscriber user.

2. The method of claim 1, further comprising:
delivering, by the computer system, the individualized message to a host system facilitating the social media site using an account of the registered user corresponding to the subscriber user.

3. The method of claim 2, further comprising:
receiving, at the computer system, a time by the administrator user for delivery of the individualized message by the computer system to the host system facilitating the social media site.

4. The method of claim 2, further comprising:
determining, by the computer system, a quantitative value of the number of individuals that can view a delivered individualized message on the one or more authorized social networks on behalf of the subscriber user; and
generating a report including the quantitative value.

5. The method of claim 2, further comprising:
generating, by the computer system, a website including at least some of the user information of the subscriber user,
wherein the individualized message includes a personalized link to the website using a virtual content tag corresponding to the subscriber user.

6. The method of claim 5, further comprising:
monitoring, by the computer system, activity of the website to determine a number of views by viewers that view the website via the personalized link in the individualized message.

7. The method of claim 6, wherein the monitoring includes collecting information about the viewers that view the website via the personalized link in the individualized message.

8. The method of claim 6, further comprising:
generating a report including the number of views.

9. The method of claim 2, further comprising:
providing, by the computer system, a preview or an alert to the subscriber user of the produced individualized message prior to the delivering of the individualized message to the host system.

10. The method of claim 1, further comprising:
receiving, at the computer system, a list of pre-authorized contacts by the subscriber user for the one or more authorized social networks.

11. The method of claim 1, further comprising:
receiving, at the computer system, a selection of at least one of (i) subscriber users to provide the individualized message, (ii) authorized social networks to provide the individualized message, or (iii) authorized social networks among the elected subscriber users to provide the individualized message.

12. The method of claim 1, wherein the entity includes a business or a group representing a brand.

13. The method of claim 11, wherein the subscriber user is affiliated with the entity by at least one of employment or membership with the entity.

14. The method of claim 1, wherein the user information includes at least one of the subscriber user's name, title, company, address, contact information, or location, or products or services produced or provided by the subscriber user.

15. A system for providing online marketing, comprising:
one or more computers in communication with a plurality of remote computing devices operated by administrator users and by subscriber users of a social network via a communication network or link, wherein an administrator user represents an entity, and a subscriber user is affiliated with the entity and is a registered user of one or more social networks via social media sites that link the subscriber user with individuals within the social network,
wherein the system is configured to receive (i) content information generated by the administrator user, (ii) user information about the subscriber user, and (iii) authorization by the subscriber user permitting access to one or more of the subscriber user's social media site accounts designated by the subscriber user, and
wherein the system is configured to produce an individualized message capable of being displayed to the individuals of the subscriber user's authorized social networks on behalf of the subscriber user,
wherein the individualized message includes the content information and at least one virtual content tag that corresponds to the user information of the corresponding subscriber user.

16. The system of claim 15, wherein the system is configured to deliver the produced individualized message to a host system facilitating the social media site using an account of the registered user corresponding to the subscriber user.

17. The system of claim 16, wherein the system is configured to receive a delivery time by the administrator user for delivery of the individualized message to the host system facilitating the social media site.

18. The system of claim 16, wherein the system is configured to determine a quantitative value of the number of the individuals that can view the delivered individualized message on the one or more authorized social networks on behalf of the subscriber user.

19. The system of claim 15, wherein the individualized message includes a personalized link to a website using a virtual content tag corresponding to the subscriber user, and wherein the system is configured to generate content for the website using at least some of the user information of the subscriber user.

20. The system of claim 19, wherein the system is configured to monitor activity of the website to determine a number of views by viewers that view the website via the personalized link in the individualized message.

21. The system of claim 20, wherein the system is configured to collect information about the viewers that view the website via the personalized link in the individualized message.

22. A method for distributing personalized content across social network platforms, comprising:
generating, at a computer system of one or more computers, content information to be distributed to a plurality of recipients across one or more social networks that provide an online linkage of registered individuals within the social network;
obtaining, at the computer system, user information from a user who is a subscriber user affiliated with the entity and is a registered user of the one or more social networks;
receiving, at the computer system, an authorization by the user to permit access of the computer system to pre-authorized connections among the registered users of the one or more authorized social networks designated by the user;
producing, by the computer system, an personalized message capable of being displayed to pre-authorized connections of the one or more authorized social networks on behalf of the user, wherein the personalized message includes the content information and at least one virtual content tag that corresponds to the user information of the user; and
delivering, by the computer system, the personalized message to a host system of the social network using an account of the user.

23. The method of claim 22, wherein the generating the content information includes receiving at least some of the content information from a client computer in communication with the computer system.

24. The method of claim 23, wherein the content information is generated by an administrator user of an entity.

25. The method of claim 22, wherein the user information is obtained by the computer system from one or more remote client computers of the user, wherein the remote client computers include one or more of a desktop computer, a laptop computer, a smartphone, a tablet, or a wearable communication device.

26. The method of claim 22, further comprising:
receiving, at the computer system, a time by the administrator user for delivery of the personalized message by the computer system to the host system facilitating the social media site.

27. The method of claim 22, further comprising:
determining, by the computer system, a quantitative value of the number of individuals that can view a delivered personalized message on the one or more authorized social networks on behalf of the user; and
generating a report including the quantitative value.

28. The method of claim 22, further comprising:
generating, by the computer system, a website including at least some of the user information of the user,
wherein the personalized message includes a link to the website using a virtual content tag corresponding to the user.

29. The method of claim 28, further comprising:
monitoring, by the computer system, activity of the website to determine a number of views by viewers that view the website via the link in the personalized message.

30. The method of claim 29, wherein the monitoring includes collecting information about the viewers that view the website via the link in the personalized message.

31. The method of claim 30, further comprising:
generating a report including the number of views.

32. The method of claim 22, further comprising:
providing, by the computer system, a preview or an alert to the user of the produced personalized message prior to the delivering of the personalized message to the host system.

33. The method of claim 22, further comprising:
receiving, at the computer system, a list of pre-authorized contacts by the user for the one or more authorized social networks.

34. A method for distributing personalized content to contacts on social network platforms, comprising:
at a computer system of one or more computers, generating a master message including content information pertaining to an entity to form a distribution message to be distributed on behalf of a subscriber user to a plurality of recipients across one or more social networks, wherein the master message is generated to include (i) one or both of text and graphics to convey the content information and (ii) dynamic tags that maps to personalized information associated with the subscriber user into the distribution message, thereby allowing the distribution message to be uniquely different for each subscriber user, and wherein the plurality of recipients include registered users of the one or more social networks having a connection with the subscriber user on the respective social network;
receiving, at the computer system, a delivery time of the distribution message;
obtaining, at the computer system, the personalized information associated with the subscriber user, wherein the subscriber user is affiliated with the entity and is a registered user of the one or more social networks;
receiving, at the computer system, an authorization by the subscriber user to permit the computer system access to authorized social networks of the one or more social networks designated by the subscriber user;
producing, by the computer system, the distribution message by inserting the corresponding personalized information for the dynamic tags in the master message such that the distribution message is capable of being displayed to the recipients on behalf of the subscriber user; and
delivering, by the computer system, the distribution message at the delivery time to one or more host computer systems corresponding to the one or more social networks using an account of the subscriber user.

35. The method of claim 34, further comprising:
receiving, at the computer system, contact data including selections of the subscriber user's connections of the one or more authorized social networks on behalf of the user.

36. The method of claim 34, wherein the personalized information includes at least one of the subscriber user's name, title, company, address, contact information, or location.

37. The method of claim 34, wherein the content information includes information pertaining to the entity's products or services.

38. The method of claim 34, further comprising:
generating the content information by receiving at least some of the content information from a client computer in communication with the computer system.

39. The method of claim 38, wherein the content information is generated by an administrator user of an entity.

40. The method of claim 34, wherein the personalized information is obtained by the computer system from one or more remote client computers of the subscriber user, wherein the remote client computers include one or more of a desktop computer, a laptop computer, a smartphone, a tablet, or a wearable communication device.

41. The method of claim 34, wherein the delivery time of the distribution message is received from an administrator user affiliated with the entity.

42. The method of claim 34, further comprising:
determining, by the computer system, a quantitative value of the number of individuals that can view the delivered distribution message on the one or more authorized social networks on behalf of the subscriber user; and
generating a report including the quantitative value.

43. The method of claim 34, further comprising:
generating, by the computer system, a website including at least some of the content information or the personalized information,
wherein the delivered distribution message includes a link to the website using a dynamic tag.

44. The method of claim 43, further comprising:
monitoring, by the computer system, activity of the website to determine a number of views by viewers that view the website via the link in the distribution message.

45. The method of claim 44, wherein the monitoring includes collecting information about the viewers that view the website via the link in the distribution message.

46. The method of claim 44, further comprising:
generating a report including the number of views.

47. The method of claim 34, further comprising:
providing, by the computer system, a preview or an alert of the produced distribution message to the subscriber user prior to the delivering of the distribution message to the one or more host computer systems.

48. The method of claim 34, further comprising:
receiving, at the computer system, a list of pre-authorized connections by the subscriber user for delivery of the distribution message.

49. A system for providing online marketing, comprising:
a network including one or more computers in communication with a plurality of remote computing devices operated by administrator users and by subscriber users of a social network, wherein an administrator user represents an entity, and a subscriber user is affiliated with the entity and is a registered user of one or more social networks via social media sites that link the subscriber user with individuals within the social network,
wherein the system is configured to receive (i) content information generated by the administrator user, (ii) user information about the subscriber user, and (iii) authorization by the subscriber user permitting access to one or more of the subscriber user's social media site accounts designated by the subscriber user, and
wherein the system is configured to produce an individualized message capable of being displayed to the individuals of the subscriber user's authorized social networks on behalf of the subscriber user,
wherein the individualized message includes the content information and at least one virtual content tag that corresponds to the user information of the corresponding subscriber user.

50. The system of claim 49, wherein the system is configured to deliver the produced individualized message to a host system facilitating the social media site using an account of the registered user corresponding to the subscriber user.

51. The system of claim 50, wherein the system is configured to receive a delivery time by the administrator user for delivery of the individualized message to the host system facilitating the social media site.

52. The system of claim 50, wherein the system is configured to determine a quantitative value of the number of the individuals that can view the delivered individualized message on the one or more authorized social networks on behalf of the subscriber user.

53. The system of claim 49, wherein the individualized message includes a personalized link to a website using a virtual content tag corresponding to the subscriber user, and
wherein the system is configured to generate content for the website using at least some of the user information of the subscriber user.

54. The system of claim 53, wherein the system is configured to monitor activity of the website to determine a number of views by viewers that view the website via the personalized link in the individualized message.

55. The system of claim 54, wherein the system is configured to collect information about the viewers that view the website via the personalized link in the individualized message.
